(19) United States
(12) Patent Application Publication
(10) Pub. No.: US 2004/0170753 A1
(43) Pub. Date: Sep. 2, 2004

(54) Electrochemical mechanical processing using low temperature process environment

(76) Inventor: Bulent M. Basol, Manhattan Beach, CA (US)

Correspondence Address: Legal Department, NuTool, Inc, 1655 McCandless Drive, Milpitas, CA, 95035, US

(21) Appl. No.: 10/705,360

(22) Filed: Nov. 10, 2003

Related U.S. Application Data
(63) Continuation-in-part of application No. 10/358,925, filed on Feb. 4, 2003.
Application No. 10/358,925 is a division of application No. 09/740,701, filed on Dec. 18, 2000, now Pat. No. 6,534,116.
(63) Continuation-in-part of application No. 10/201,604, filed on Jul. 22, 2002.
(63) Continuation-in-part of application No. 10/201,606, filed on Jul. 22, 2002.
(63) Continuation-in-part of application No. 10/379,265, filed on Mar. 3, 2003.
(63) Continuation-in-part of application No. 09/919,788, filed on Jul. 31, 2001.
(63) Continuation-in-part of application No. 09/961,193, filed on Sep. 20, 2001.

(51) Int. Cl. B05D 5/12

(52) U.S. Cl. 427/58; 427/299

(57) ABSTRACT

An apparatus and method for processing a conductive surface of a wafer to form a planar layer is disclosed. The method for processing comprises maintaining a low temperature processing environment, wetting the conductive surface with an electrolyte solution having at least one additive disposed therein, a first amount of the additive becoming adsorbed on the top portion and a second amount of the additive becoming adsorbed on the cavity portion, applying an external influence to the top portion, the external influence removing a part of the first amount of the additive adsorbed on the top portion, and processing the conductive top surface before the additive re-adsorbs onto the top portion to provide a planar layer. Advantages of the invention include improved control of deposited metal to improve device consistency and yield.

### RELATED APPLICATIONS

This application is a continuation in part of U.S. patent application Ser. No. 10/358,925 filed Feb. 4, 2003 (NT-020 D), which is a divisional application of U.S. patent application Ser. No. 09/740,701 filed Dec. 18, 2000 (NT-020), which is now U.S. Pat. No. 6,534,116. This application is also a continuation in part of U.S. patent application Ser. No. 09/919,788 filed Jul. 31, 2001 (NT-212) and U.S. patent application Ser. No. 09/961,193 filed Sept. 20, 2001 (NT-225), both are also continuation in part of above U.S. patent application Ser. No. 09/740,701 filed Dec. 18, 2000 (NT-020) and now U.S. Pat. No. 6,534,116. All above patent applications are incorporated herein by reference.

### FIELD

The present invention relates to manufacture of semiconductor integrated circuits and, more particularly to a method for efficient planarization of conductive layers during deposition on or removal from workpiece surfaces.

### BACKGROUND

Conventional semiconductor devices generally include a semiconductor substrate, such as a silicon substrate, and a plurality of sequentially formed dielectric interlayers such as silicon dioxide and conductive paths or interconnects made of conductive materials. In an integrated circuit, multiple levels of interconnect networks laterally extend with respect to the substrate surface. Interconnects formed in sequential layers can be electrically connected using vias or contacts. Copper and copper-alloys have recently received considerable attention as interconnect materials because of their superior electro-migration and low resistivity characteristics. The interconnects are usually formed by filling copper in features or cavities etched into the dielectric layers by a deposition process. The preferred method of copper deposition is electrochemical deposition.

In a typical process, first an insulating layer is formed on the semiconductor substrate. Patterning and etching processes are performed to form features or cavities such as trenches and vias in the insulating layer. Then, a barrier/glue layer and optionally a seed layer are deposited over the patterned surface and a conductor such as copper is electroplated to fill all the features. However, the plating process, in addition to filling the features with copper, also deposits excess copper over the top surface of the substrate. This excess copper is called an “overburden” and needs to be removed during a subsequent process step. In standard plating processes this overburden copper has a large topography since the Electrochemical Deposition (ECD) process coats large features on the wafer in a conformal manner. Conventionally, after the copper plating, CMP process is employed to first globally planarize this topographic surface and then to reduce the thickness of the overburden copper layer down to the level of the surface of the barrier layer, which is also later removed leaving conductors only in the cavities. CMP is a costly and time consuming process. High pressures used in the CMP processes also damage low-k dielectrics, which are mechanically weaker than the silicon oxide. Therefore, minimizing CMP step in an integration process is a goal for all IC manufacturers.

During the copper electrodeposition process, specially formulated plating solutions or electrolytes are used. These electrolytes typically contain water, acid (such as sulfuric acid), ionic species of copper, chloride ions and certain additives which affect the properties and the plating behavior of the deposited material. Typical electroplating baths contain at least two of the three types of commercially available additives such as accelerators, suppressors and levelers. It should be noted that these additives are sometimes called different names. For example, the accelerator may be referred to as a brightener and the suppressor as a carrier in the literature. Functions of these additives in the electrolyte and the role of the chloride ion are widely known in the field (see for example, Z. W. Sun and G. Dixit, “Optimized bath control for void-free copper deposition”, Solid State Technology, Nov. 2001, page. 97), although the details of the mechanisms involved may not be fully understood or agreed upon.

Suppressors are typically polymers formulated from polyethylene glycol-PEG or polypropylene glycol-PPG and are believed to attach themselves to the copper surface forming a high resistance film and suppressing the material deposited thereon. Accelerators are typically organic disulfides that enhance copper deposition on portions of the substrate surface where they are adsorbed in the presence of suppressors. The interplay between these two additives and possibly the chloride ions determines the nature of the copper deposit.

A conventional electrochemical deposition process can be exemplified with FIGS. 1A-1C. FIG. 1A illustrates a substrate 10 including a small feature 12 such as a via and a large feature 14 such as a trench. The features are formed into a dielectric layer 16 deposited on the surface of the substrate 10. The dielectric layer 16 has a top surface 18. In this example, the vias 12 are narrow and deep; in other words, they have high aspect ratios (i.e., their depth to width ratio is large). Typically, the widths of the vias 12 are sub-micron. The trench 14, on the other hand, is typically wide and has a small aspect ratio. In other words, the width of the trench 14 may be 5-50 times or even greater than its depth. The features and the surface of the dielectric are coated with a barrier/glue or adhesion layer 20 and a copper seed layer 22. The barrier layer 20 may be made of Ta, TaN or combinations of any other materials that are commonly used in copper electrodeposition. The seed layer 22 is deposited over the barrier layer 20, although for specially designed barrier layers there may not be a need for a seed layer.

As shown in FIG. 1B, after depositing the seed layer 22, copper is generally electrodeposited thereon from a suitable acidic or non-acidic plating bath or bath formulation to form the copper layer 24. During this step, an electrical contact is made to the copper seed layer 22 and/or the barrier layer 20 so that a cathodic (negative) voltage can be applied thereto with respect to an anode (not shown) of the electrodeposition system. The copper is electrodeposited using the specially formulated plating solutions, as discussed above. By adjusting the amounts of the additives, such as the chloride ions, suppressor/inhibitor, and the accelerator, it is possible to obtain bottom-up copper film growth in the via 12.

The copper completely fills the via 12 and is generally uniform in the trench 14, but does not completely fill the trench 14 because the additives that are used are not operative in large features. For example, it is believed that the bottom up deposition into the via 12 occurs because the suppressor/inhibitor molecules attach themselves to the top of the via 12 to suppress the material growth thereabouts. These molecules cannot effectively diffuse to the bottom surface of the via 12 through the narrow opening. Preferential adsorption of the accelerator on the bottom surface of the via 12 results in faster growth in that region, resulting in bottom-up growth and the copper deposit profile as shown in FIG. 1B. Without the appropriate additives, copper can grow on the vertical walls as well as the bottom surface of the via 12 at the same rate, thereby causing defects such as seams and/or voids.

Adsorption characteristics of the suppressor and accelerator additives on the bottom surface of the large trench 14 is not expected to be any different than the adsorption characteristics on the top surface 18 of the dielectric or the field regions of the substrate. Therefore, the thickness t₁ of the copper layer 24 at the bottom surface of the trench 14 is about the same as the thickness t₂ of the layer 24 over the field regions 18, i.e. copper film is conformal in the large trench.

As can be expected, to completely fill the trench 14 with the copper, further plating is required. FIG. 1C illustrates the resulting structure after additional copper plating. In this case, the thickness t₃ of the copper layer 24 over the field regions 18 is relatively large and there is a step S₁ from the field regions 18 to the top of the copper in the trench 14. The value of s₁ is typically very close to the value of the depth of the trench 14. For IC applications, by utilizing CMP or other material removal process, the copper, as well as the barrier layer 20 on the field regions 18 are removed, thereby leaving the copper only within the features. These removal processes increase the manufacturing cost.

Thus far, much attention has been focused on the development of copper plating chemistries and plating techniques that yield bottom-up filling of small features on substrates. This is necessary because, as mentioned above, lack of bottom-up filling can cause defects in the small features. As part of these development efforts, it was discovered that the filling behavior of the small features could be affected not only by the solution chemistry, but also by the type of the power supply used for electrodeposition. Both DC and pulsed power supplies can be used in the deposition of the copper films. Although the exact roles of the plating solution additives and their interaction with the applied voltage waveforms are not well understood, it is clear that the kinetics of the additive adsorption and diffusion processes influence the way metals deposit on non-planar substrate surfaces.

As mentioned above, special bath formulations and pulse plating processes have been developed to obtain bottom-up filling of the small features. However, these techniques have not been found effective in filling the large features. In large features, the additives can freely diffuse in and out of them. The use of standard pulse plating techniques in conjunction with the commonly used additive systems containing chloride ions, accelerators and suppressors/inhibitors do not yield accelerated growth from the bottom surface of the features where the width of the feature is considerably larger than its depth. The growth of copper in such features is conformal and the film thickness deposited on the bottom surface of the large features is approximately the same as that deposited on the field regions.

Methods and apparatus to achieve accelerated bottom-up plating in small as well as large features on a substrate would be invaluable in terms of process efficiency and cost since such a process would yield a copper deposit that is generally planar as illustrated in FIG. 2. The thickness t₅ of a copper layer 26 over the field regions 18 in this example is smaller than the traditional case as shown in FIG. 1C, and the step height S₂ would also be much smaller. Removal of the thinner copper layer 26 in FIG. 2 by CMP or other methods would be easier, providing important cost savings.

A technique that can reduce or totally eliminate copper surface topography for all feature sizes is the Electrochemical Mechanical Processing (ECMPR). This process has the ability to minimize or eliminate steps S1, S2 and provide thin layers of planar conductive material on the workpiece surface, or even provide a workpiece surface with no or little excess conductive material. This way, CMP process can be minimized or even eliminated. The term “Electrochemical Mechanical Processing (ECMPR)” is used to include both Electrochemical Mechanical Deposition (ECMD) processes as well as Electrochemical Mechanical Etching (ECME), which is also called Electrochemical Mechanical Polishing (ECMP). It should be noted that in general both ECMD and ECME processes are referred to as electrochemical mechanical processing (ECMPR) since both involve electrochemical processes and mechanical action on the workpiece surface. The mechanical action can be provided by sweeping the substrate surface with a workpiece surface influencing device (WSID) such as a sweeper, pad, blade or wand. The WSID may be porous or may have openings, which allow a process solution to flow towards or from the substrate surface during the ECMPR.

Descriptions of various ECMPR systems and processes, can be found in the following exemplary patents and pending applications, all commonly owned by the assignee of the present invention: U.S. Pat. No. 6,176,992 entitled “Method and Apparatus for Electrochemical Mechanical Deposition,” U.S. Pat. No. 6,354,116 entitled “Plating Method and Apparatus that Creates a Differential Between Additive Disposed on a Top Surface and a Cavity Surface of a Workpiece Using an External Influence,” U.S. Pat. No. 6,471,847 entitled “Method for Forming Electrical Contact with a Semiconductor Substrate” and U.S. Pat. No. 6,610,190 entitled “Method and Apparatus for Electrodeposition of Uniform Film with Minimal Edge Exclusion on Substrate.” U.S. application with Ser. No. 09/960,236 filed on Sep. 20, 2001, entitled “Mask Plate Design”, and U.S. application Ser. No. 10/155,828 filed on May 23, 2002 entitled “Low Force Electrochemical Mechanical Processing Method and Apparatus.” These methods can deposit metals in and over feature sections on a wafer in a planar manner.

### SUMMARY

The invention provides an apparatus and method of processing a wafer having a conductive surface in a wafer processing system. A method for processing the conductive surface of a wafer is disclosed. The method comprises maintaining a low temperature processing environment, wetting the conductive surface with an electrolyte solution having at least one additive disposed therein, a first amount of the additive becoming adsorbed on the top portion and a second amount of the additive becoming adsorbed on the cavity portion, applying an external influence to the top portion, the external influence removing a part of the first amount of the additive adsorbed on the top portion, and processing the conductive top surface before the additive re-adsorbs onto the top portion to provide a planar layer.

In one aspect of the invention, the maintaining a low temperature step includes contacting the wafer with process tools having a low temperature.

In another aspect of the invention, the maintaining a low temperature step includes chilling a substrate carrier and contacting the wafer with the chilled substrate carrier.

In another aspect of the invention, the maintaining a low temperature step includes wetting the conductive surface with the electrolyte at a low temperature.

Advantages of the invention include improved control of deposited metal to improve device consistency and yield.

### DRAWINGS

The invention is described in detail with reference to the drawings, in which:

FIGS. 1A-1C illustrate a conventional electrochemical deposition process;

FIG. 2 illustrates a copper deposit that is generally planar;

FIG. 3 illustrates a substrate having a feature or cavity and a top surface or a field region to be processed with an electrochemical process;

FIG. 4 illustrates an instant at a beginning of the process of the surface of the substrate 100 in an electrochemical mechanical processing system;

FIGS. 5 illustrates accelerator and suppressor molecules of the substrate 100 as a mechanical action is applied to the field region;

6 illustrates the substrate 100 a period of time after mechanical action has been applied;

FIG. 7 illustrates a planarized layer which exemplifies the significance of results from the low temperature process in accordance with the present invention;

FIG. 8 illustrates a graph of accelerator to suppressor ratio as mechanical action is applied;

FIG. 8A illustrates a graph of current verses time as mechanical action is applied;

FIG. 9 illustrates a planarized conductive layer in accordance with the present invention;

FIG. 10 illustrates a conductive layer showing unevenness due to room temperature process solution; and

FIG. 11 illustrates an exemplary embodiment of a processing system in accordance with an embodiment of the present invention.

### DETAILED DESCRIPTION

The present invention provides a method and system to form a planar conductive layer by controlling the additive adsorption rate on the surface of a semiconductor substrate during an electrochemical process. The additive adsorption rate may be defined as the rate that the additive species, such as accelerators, suppressors and levelers attach themselves to the substrate surface from a process solution. The process of the present invention controls the adsorption rate or the transient time for adsorption by slowing-down the adsorption of the additives during an electrochemical deposition process. In one embodiment, the process of slowing down the additive adsorption rate is performed in combination with a mechanical action that is applied to the surface of the substrate that is in contact with the process solution. Application of mechanical action disturbs the additives on the top surface or field region but not so much the additives in the cavities, therefore the additives in the cavities continue contributing to the deposition process. However, since the additives on the field surface are swept away from the field region with the mechanical action, they can only start contributing when they are re-adsorbed onto the field region. Therefore, there exists a difference in material deposition rate on the field region in comparison to the material deposition rate in the cavities for a transient time period, which produces planarization and results in a planar layer. The mechanical action on the field region promotes a deposition rate on the field region that is lower than the deposition rate in the cavities. The readsorption rate on the field region can be further lowered by the process of the present invention to produce a thinner planar surface in a shorter process time.

In an embodiment of the present invention, slowing down of the readsorption rate of the additives after the mechanical action is provided by reducing the temperature of the process environment that includes the substrate and the process solution during the electrochemical process. The temperature of the process environment may be reduced in many possible ways, for example, by reducing the temperature of the process tools or solutions that are in contact with the substrate. In one example, a substrate carrier surface on which the substrate is held during the process may be cooled down to lower the temperature of the substrate selectively. This way the local temperature of the sheet of process solution touching the substrate surface is reduced. In another example, temperature of the whole process solution, such as an electroplating solution, can be lowered.

In one possible process sequence of the present invention, a low temperature process solution including accelerator and suppressor additives are used to electrochemically deposit copper onto a wafer surface using electrochemical mechanical deposition process. The wafer surface may include cavities and field regions. During the process, after the accelerators and suppressors are swept away with the mechanical action such as with a sweeper sweeping the surface, predetermined low temperature of the process solution slows down the accelerator readsorption onto the field region. As a result, the copper deposition rate onto the field region is highly retarded in comparison to the copper deposition rate in the cavities. This in turn forms a thinner planar copper layer on the wafer in a shorter time.

Reference will now be made to the drawings wherein like numerals refer to like parts throughout. FIG. 3 illustrates a substrate 100 having a feature 102 or a cavity and a top surface 104 or a field region to be processed with an electrochemical process, such as electrochemical mechanical deposition process (ECMD) of the present invention. In this embodiment, the feature is preferably a low aspect ratio (depth is shorter than width) feature having interior surface 106. The field region 104 and the interior surface 106 of the feature define a surface 108 that is electrically conductive. The substrate may represent a portion of a semiconductor wafer that has many high and low aspect ratio features to be filled using the process of the present invention. The surface 108 may be the surface of a seed layer or a barrier layer. Alternately, the substrate may already have a pre-plated surface and the pre-plating may have filled all or most of the small high-aspect ratio features. The substrate may have one or multiple dielectric and conductive layers and materials.

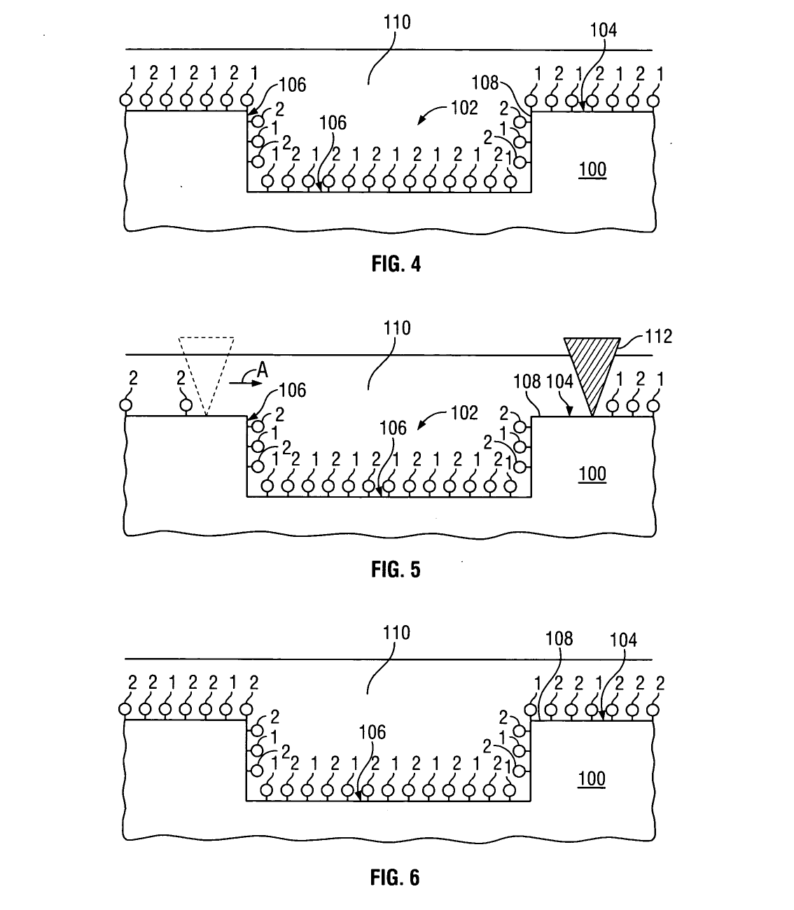

FIG. 4 illustrates an instant at the beginning of processing the surface of the substrate 100 in an electrochemical mechanical processing system (not shown). A process solution 110 contacts the field region 104 and the feature 102 of the substrate 100 while a potential difference is applied between the surface 108 and an electrode of the system. Both the substrate surface and the electrode (not shown) are wetted by the process solution. In this embodiment, the process solution 110 is an electroplating solution having additive molecules such as accelerators 1 and suppressors 2. Temperature of the process solution is kept in a predetermined low temperature range of 1-15 C, preferably in the range of 5-10 C. At the beginning of the electrochemical process, accelerator molecules 1 and the suppressor molecules 2 are attracted to the field region 104 and the interior surface 106 of the low aspect ratio feature. The accelerator and suppressor molecules at this stage are almost uniformly distributed on the surfaces 104 and 106 at their respective steady state surface concentrations. In other words, they are at their steady state adsorption levels. In FIG. 4, the concentration or coverage of the accelerator molecules on the surfaces 104 and 106 is shown to be almost equal to the coverage of the suppressors on the same surfaces 104 and 106, to be able to explain the process clearly. In actuality, the accelerator concentration in the process solution may be much less than the suppressor concentration and thus its surface coverage may be much less than the suppressor surface coverage. However, what is important here is the relative change in the suppressor and accelerator coverage once the mechanical action is applied to the surface.

As shown in FIG. 5, as a mechanical action is applied to the field region 104, the accelerator and suppressor molecules 1 and 2 may be swept from the field region 104 into the process solution 110, which is kept in the predetermined low temperature. In this embodiment, the mechanical action is applied through a workpiece surface influencing device (WSID) 112 which sweeps the field region 104 in the direction of arrow A. As previously mentioned, the WSID may be a sweeper, pad, blade or a wand that can be brought into physical contact with the surface of the substrate as a relative motion applied between the WSID and the substrate surface. Alternately, WSID may not touch the surface of the substrate but it may be in close proximity of the surface to impart external influence to the surface to influence the populations of the additives as will be discussed next. Description of WSID may be found in U.S. Pat. No. 6,413,388 entitled Pad Designs and Structures for a Versatile Materials Processing Apparatus, U.S. patent application Ser. No. 09/960,236 entitled Mask Plate Design filed Sep. 20, 2003, and U.S. patent application Ser. No. 10/155,828 entitled Low Force Electrochemical Mechanical Deposition Method and Apparatus filed May 23, 2002, all assigned to the assignee of the present invention, the entire disclosures of which are incorporated herein by reference. As shown in FIG. 5, during the mechanical action, the accelerator and suppressor molecules 1 and 2 on the interior surface 106 of the feature 102 are not directly disturbed by the mechanical action of the WSID and may substantially keep their concentration ratios during the mechanical action.

The mechanical action may remove most of the population of the accelerator molecules from the field region 104 due to the fact that the accelerator molecules are generally loosely adsorbed onto the field region 104. The suppressor molecules, on the other hand, are generally strongly adsorbed onto the field region. Therefore, the mechanical action may not remove the entire population of the suppressor molecules 2 from the field region 104. As exemplified in FIG. 5, a certain amount of the suppressor molecules can be left attached to the field region 104.

One other way of achieving the additive differential between the top surface and cavity surface is to use a much higher concentration of suppressors compared to accelerators. In this case when the sweeping is done we can assume two cases: a) substantially all additives are swept away and they start readsorbing after sweeper is out of the way, b) a certain percentage of additives are swept away irrespective of their type, and they start readsorbing after the sweeper is out of the way. In both above cases, since the concentration of suppressors in the process solution is much higher than the accelerators, suppressors will and cover the swept surface first right after the sweeper is removed from the surface, therefore causing more suppression of the deposition current at the surface. As will be described below, the present invention achieves to slow down the re-adsorption of accelerators, and therefore to increase current suppression at the top surface. For a process that is carried out by applying constant current between the system electrode and the surface 108, suppression of the deposition current on the field region 104 results in a relative increase in the deposition current onto the interior surface 106 of the feature. Therefore, more material deposits into the feature compared to the field region, giving rise to planarization. Use of constant voltage in the process rather than constant current, gives similar results.

In a room temperature process solution, the accelerator and suppressor molecules 1 and 2, which are dispersed away by the mechanical action would readsorb onto the field region 104 shortly after the mechanical action. However, in the process of the present invention, the low temperature of the process solution delays the readsorption rate of the molecules, especially, the accelerator molecules 1 onto the field region 104. In the same low temperature, the readsorption rate of the suppressor molecules may also be slowed down, however, by keeping their concentration much higher (more than 10 times, preferably more than 100 times) than the accelerators their surface coverage rate is not affected much by the lower temperature. Therefore, right after the sweeper leaves a location of the top surface or field region, available sites on that field region portion would be mostly populated by the suppressor molecules 2 as shown in FIG. 5, causing deposition suppression on the field region as described before. It should be noted that the additives within the cavity does not get disturbed much during this process. Therefore lower temperature and the associated change in readsorption kinetics do not negatively impact their relative populations.

FIG. 6 illustrates the situation a period of time after the sweeping is done. As can be seen in FIG. 6 the field region is generally populated by the suppressor molecules in comparison to a few accelerator molecule sites after a predetermined time following the mechanical action. This pre-determined time may be in the range of 1-2000 milliseconds or higher depending upon the additives selected. Low concentration of deposition promoting accelerators on the field region and high concentration of deposition retarding suppressors highly retard copper deposition rate on the field region 104. The relatively high coverage of accelerator molecules in the feature however, accelerates the filling process of the feature and fills the feature before any significant copper deposition occurs onto the field region 104, in a short time. It should also be clear from this discussion that unlike filling high aspect ratio features where the nature of suppressor and accelerator need to be optimized carefully to avoid formation of defects such as voids and seams in sub-micron size trenches and vias, the planarization process of the present invention has a much wider process window since the feature size is much larger. Therefore, suppressors and accelerators can be freely optimized to improve planarization. From the discussion above, it should be clear that selecting and accelerator with long re-adsorption time would increase planarization efficiency.

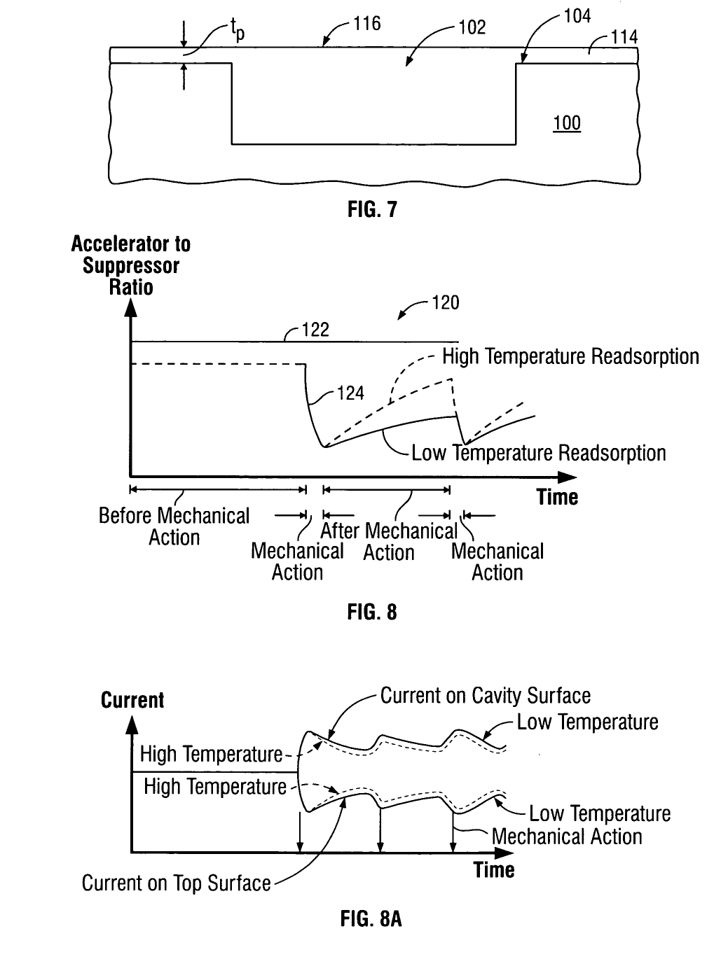

As shown in FIG. 7, the process forms a copper layer 114 with a planar surface 116 on the substrate 100. The copper layer 114 fills the feature 102 and covers the field regions 104. The thickness tₚ of the planar layer 114 on the field region 104 is substantially smaller than a film formed using room temperature or warmer process solutions.

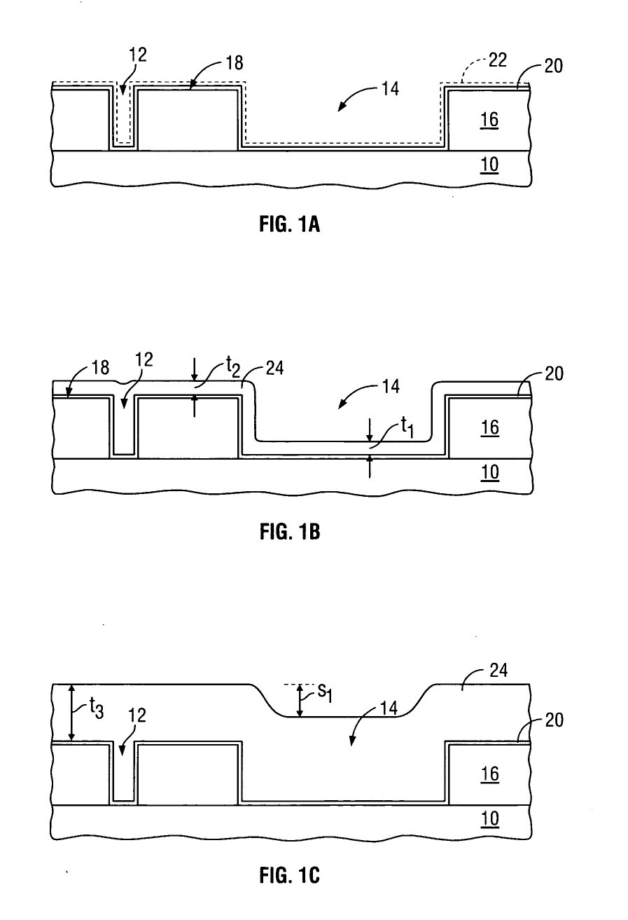

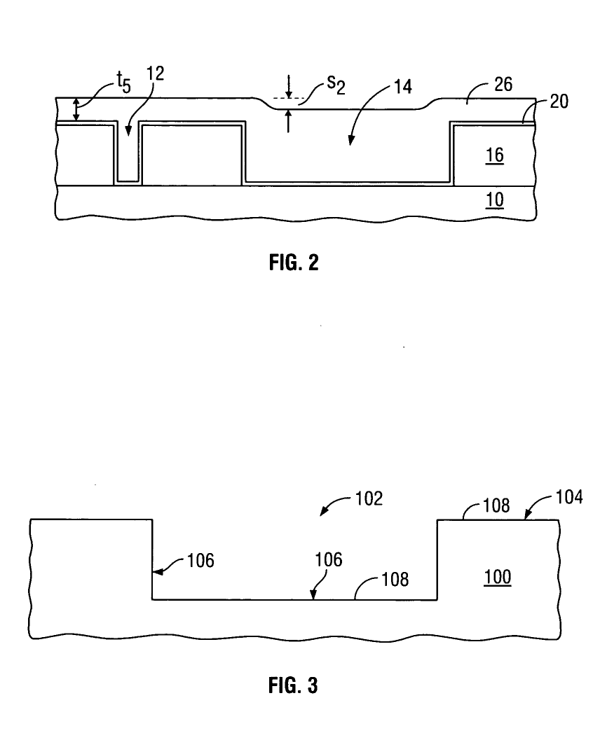

Although the process of the invention is described using a single process solution with a predetermined additive concentrations to fill the feature 102 as explained above, the present invention may be performed using multiple steps using multiple process solutions having different additive concentrations. Further, the present invention may be performed on substrates already having non-planar copper layers 24 and 26 as exemplified in FIGS. 1B, 1C and 2, to form a planar copper layer, or to planarize the existing non-planar copper layers. For example, the copper layer 24 with step S₁ shown in FIG. 1c may be formed using an electrochemical deposition (ECD) step using a room temperature process solution having a different additive chemistry than the cold process solution that would be used in the subsequent ECMD process step. Accordingly, in a first process step a process using solution having a first additive chemistry, a non planar copper layer such as layer 24 is deposited using ECD. In the following step, a cold process solution having a second additive chemistry is used to form a planar copper layer using the above described ECMD process. As an example, the first chemistry may contain additives that are designed to fill high aspect ratio features without defects. Such additives include accelerators, suppressors, levelers and defect reducing agents. These additives are not necessarily optimized for filling large, low aspect ratio features. The cold process solution having the second additive chemistry, on the other hand, contains additives that are designed to planarize low aspect ratio features. Such additives include accelerators and suppressors and as explained before, fast adsorbing suppressors and slow adsorbing accelerators may be selected. Also it may be beneficial to select accelerators that easily desorb under the effect of WSID. It should be noted that low temperature process solutions may not be good for filling high aspect ratio features. However, as demonstrated in this invention, low temperature solutions improve the filling or planarization efficiency of low aspect ratio features in the exemplary ECMD process.

Although, use of two different chemistries designed for filling high aspect ratio and low aspect ratio features using respectively ECD and ECMD processes is preferred, the same process solution may also be used to perform both process steps by keeping it in room temperature at the ECD step but lowering its temperature at the ECMD step. Examples of such electrochemical processes including electrochemical deposition, electrochemical mechanical deposition and electrochemical mechanical polishing can be found in the following patent applications. U.S. patent application Ser. No. 10/201,604 entitled Multi-Step Electrodeposition Process filed Jul. 22, 2002, U.S. patent application Ser. No. entitled Planar Metal Electrodeposition filed . . . , and U.S. patent application Ser. No. 10/379,265 entitled Defect Free Thin and Planar Film Deposition filed Mar. 3, 2003, all assigned to common assignee of the present invention and all incorporated herein by reference.

FIG. 8 further exemplifies the significance of the low temperature process of the present invention. As represented by curve 122 in FIG. 7, accelerator to suppressor ratio in the feature 102 does not appreciably change during the deposition process. However, as represented by the curve 124, accelerator to suppressor ratio on the field region varies during the process. As indicated by the curve 124, the mechanical action causes an abrupt drop in the accelerator to suppressor ratio at the top surface. After the mechanical action (i.e. after the sweeper sweeps a location on the wafer surface and leaves that location) however, owing to the slow readsorption rate of the accelerator molecules in low temperature process solution, accelerator to suppressor ratio recovers very slowly on the field surface. For comparison reasons, as depicted with the dotted line, a faster readsorption rate for the accelerator molecules in room temperature speeds up the recovery of accelerator to suppressor ratio on the field region. Therefore, suppression of the current at the top surface is not as strong in room temperature or high temperature electrolytes. When the sweeper periodically sweeps the surface, the suppression effect is sustained. Another way of explaining the mechanism in FIG. 8 is shown in FIG. 8A, where the deposition current density on the top surface and the deposition current density into the feature is shown. As can be seen from this figure, right after mechanical action on the surface (sweep) current on the top surface is suppressed and the current into the cavity is increased. At low temperature, suppressed current on the top and enhanced current on the cavity internal surface are sustained better compared to high temperature as can be seen from this figure.

A series of experiments were conducted to compare the average step values of room temperature deposited samples and low temperature deposited samples. In the experiments, ECMD process was used on sample substrates having 100 micrometer wide trenches with a depth of 0.5 um. First copper was plated using a conventional electrochemical deposition process so that a step height of 0.5 micron was formed on the filled large trenches, demonstrating conformal deposition and no planarization. When room temperature process environment and a WSID sweeping the surface at 50 rpm was used, after the same plating charge a step of 0.38 um was measured showing there was planarization. When the process of the present invention was performed to fill the recesses using an electroplating solution at 10° C. and a WSID sweeping the surface at 50 rpm, the step height is reduced to 0.28 microns indicating higher planarization efficiency. For both experiments 4 A-min of charge was plated on 200 mm diameter wafers. As can be seen the low temperature process solution provided a 43% improvement in planarization.

After forming the planar copper layer 114, the process of the present invention may continue with a material removal step to reduce the thickness tₚ of the planar layer 114. As described above, a planar layer may be formed using a single step process or a multiple step processes employing the same or different chemistries. A preferred material removal process is electroetching or electropolishing process, which can be performed either using an electropolishing solution or the same process solution used in the previous step of electrochemical mechanical deposition. If the same process solution is used, the electropolishing process can be performed after the ECMD process by reversing the polarities between the substrate and the electrode of the electrochemical process module. If the WSID is contacted to the substrate surface during this removal step, the process is called ECME or ECMP.

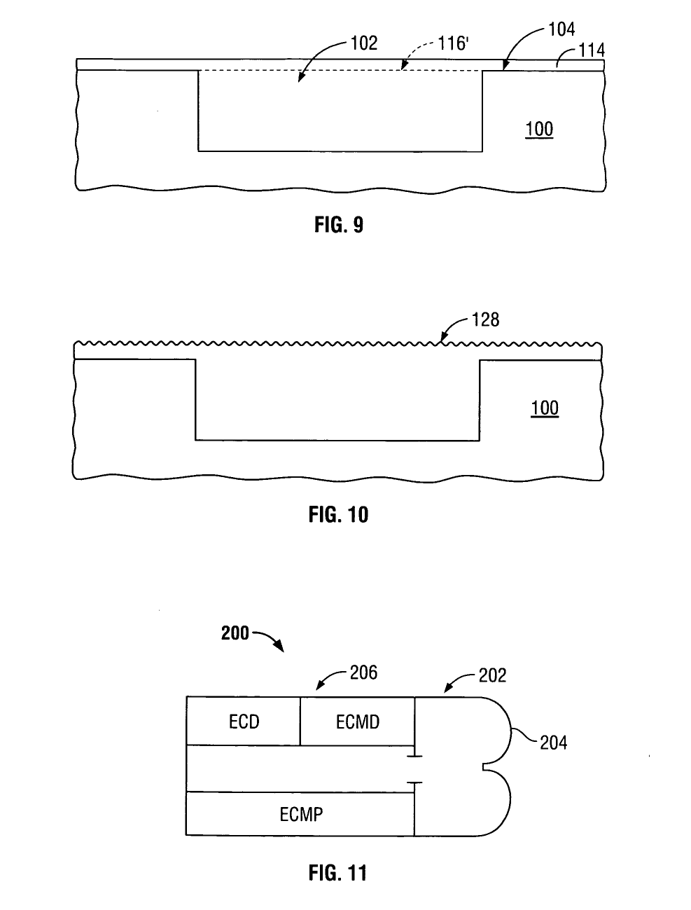

FIG. 9 illustrates electrochemical polishing (ECMP) process of the planar layer 114 to uniformly reduce its thickness to a desired thickness value in the same ECMD electrolyte that was used to plate and planarize the layer. In fact, electropolishing may be continued until all the copper on the field regions 104 is removed, confining the remaining copper in the feature 114 and forming the planar surface depicted with dotted line 116′. The electropolishing process uses a low temperature process solution having a temperature range of 5-10° C. The low temperature process solution of the present invention removes the planar copper in a smooth and planar fashion. As shown in FIG.10, if the same electropolish process is applied on the layer 114 using a room temperature process solution, electropolishing of the surface 116 results in a surface 128 having micro level non-uniformity or surface roughness. Unlike the previous case described in FIG. 9, this surface roughness will not allow complete removal of the planar layer from the field regions because small amount of copper will also be removed from the trench itself. In experiments done with removing planar copper layers in the ECMD module by reversing the voltage, the surface roughness was reduced by 40-60% by cooling the electrolyte or process solution from 23 C. to 10 C.

Example of an integrated system 200 that can be used to practice the present invention is schematically shown in FIG. 11. The system 200 may have a load/unload section 202 to load and unload wafer boxes 204, having the wafers to be processed, and a process section 206. Wafers from the boxes are delivered to the process section 206 using one or more robots (not shown) which may be located either in the process section or the load/unload section, or both sections. The process section 206 may have an ECD module 208, ECMD module and ECMP module. It should be noted that other modules such as cleaning units, drying units, annealing modules, edge copper removers and CMP modules may also be added to the system of FIG. 11.

Accordingly, in one process sequence, wafer to be processed may be first copper plated in the ECD module with a first process solution in room temperature. The wafer is then delivered to the ECMD module to form the thin planar layer using the low temperature process solution. Alternatively, the ECD step may be skipped and in a single deposition step, the planar layer may be electroplated in the ECMD chamber. Once the thin planar layer is formed, the wafer is delivered to ECMP chamber for material removal in a low temperature process solution. Alternately, electropolishing may also be done in the ECMD chamber using the cold solution and by reversing the deposition potential.

Although various preferred embodiments have been described in detail above, those skilled in the art will readily appreciate that many modifications of the exemplary embodiment are possible without materially departing from the novel teachings and advantages of this invention. Although the invention is described for processing copper layers, other metallic and alloy layers can also be deposited and etched using the present invention.

I claim:

1. A method of processing a wafer having a conductive surface, the conductive surface including a top portion and a cavity portion, the method comprising the steps:
maintaining a low temperature processing environment;
wetting the conductive surface with an electrolyte solution having at least one additive disposed therein, a first amount of the additive becoming adsorbed on the top portion and a second amount of the additive becoming adsorbed on the cavity portion;
applying an external influence to the top portion, the external influence removing a part of the first amount of the additive adsorbed on the top portion; and
processing the conductive top surface before the additive re-adsorbs onto the top portion to provide a planar layer.

2. The method of claim 1, wherein the step of maintaining a low temperature includes contacting the wafer with process tools having a low temperature.

3. The method of claim 2 further comprising a substrate carrier wherein the step of maintaining a low temperature includes:
chilling the substrate carrier; and
contacting the wafer with the chilled substrate carrier.

4. The method of claim 1, wherein the step of maintaining a low temperature includes wetting the conductive surface with the electrolyte solution at a low temperature.

5. The method of claim 1, wherein the low temperature is between 1-15 degrees C.

6. The method of claim 1 further comprising a sweeper wherein the step of applying an external influence includes sweeping the conductive surface with the sweeper.

7. The method of claim 6, wherein the step of sweeping the conductive surface includes contacting the sweeper with the conductive surface.

8. The method of claim 1, wherein the step of processing includes removing a conductive material from the conductive surface.

9. The method of claim 1, wherein the step of processing includes plating a conductive material on to the conductive surface.

10. The method of claim 1 further comprising wetting the conductive surface with a second electrolyte solution having a different additive concentration to provide the planer layer.

11. A method of processing a wafer having a conductive surface, the conductive surface including a top portion and a cavity portion, the method comprising the steps:
wetting the conductive surface with an electrolyte solution having at least one additive disposed therein, a first amount of the additive becoming adsorbed on the top portion and a second amount of the additive becoming adsorbed on the cavity portion;
applying an external influence to the top portion, the external influence removing a part of the first amount of the additive adsorbed on the top portion;
processing the conductive top surface before the additive re-adsorbs onto the top portion;
chilling the electrolyte solution;
wetting the conductive surface with the chilled electrolyte solution;
reapplying the external influence to the top portion; and
processing the conductive top surface to provide a planar layer.

12. The method of claim 11, wherein the step of chilling the electrolyte solution includes chilling a second electrolyte solution.

13. The method of claim 12, wherein the second electrolyte solution includes an additive concentration different from the electrolyte solution and the step of wetting the conductive surface with the chilled electrolyte solution includes wetting the top surface with the chilled second electrolyte solution.

14. The method of claim 11, wherein the chilled electrolyte solution is between 1-15 degrees C.

15. The method of claim 11 further comprising a sweeper wherein the step of applying an external influence includes sweeping the conductive surface with the sweeper.

16. The method of claim 15, wherein the step of sweeping the conductive surface includes contacting the sweeper with the conductive surface.

17. The method of claim 11, wherein the step of processing includes removing a conductive material from the conductive surface.

18. The method of claim 11, wherein the step of processing includes plating a conductive material on to the conductive surface.
